(19) United States
(12) Patent Application Publication
(10) Pub. No.: US 2020/0238550 A1
(43) Pub. Date: Jul. 30, 2020

(54) MULTI SECTIONAL SAFETY RAZOR

(71) Applicant: AYDIN SARVE, L.I.C., NY (US)

(72) Inventor: AYDIN SARVE, L.I.C., NY (US)

(21) Appl. No.: 16/262,896

(22) Filed: Jan. 30, 2019

(51) Int. Cl. B26B 21/22

(52) U.S. Cl. CPC B26B 21/222

(57) ABSTRACT

The multi-sectional safety razor invention bi-furcated the traditional one and a half (1.5) inch single blade into equal pieces ranging from at least 2 and up in number. These smaller square blades bear a hollowed out center hole which allows them to be fixed and looked into the razor head base. The razor base is made of plastic and there are plastic pegs protruding outwardly. The individual segmented razors look in place on the pegs. A clear cover is heat fused to the razor enclosing the segmented razors to the razor head base.

This multi-sectional security razor makes this razor a safe alternative to the existing disposable products as used by the prison systems, hospitals, facilities and the general public.

### CROSS REFERENCE TO RELATED APPLICATIONS

NOT APPLICABLE

### STATEMENT REGARDING FEDERALLY SPONSORED RESEARCH OR DEVELOPMENT

NOT APPLICABLE

### DESCRIPTION OF ATTACHED APPENDIX

NOT APPLICABLE

### BACKGROUND OF THE INVENTION

This invention relates to the field of personal grooming and hygiene. This product can be used by both women and men. This invention is a modification of the traditional disposable razor.

This invention's modification targets a specific audience from the onset. The specific audience targeted is the prison systems all over the world, mental health hospitals and related facilities.

These facilities gratuitously hand-out disposable razors so that their clients can tend to their grooming needs. The traditional disposable razor features one long blade held together by cover.

These blades can be one and half (1.5) inches long and can be removed from the plastic razor mold and turned into weapons or tools for un-intended purposes posing a threat to guards, inmates and or hospital personnel. This problem is solved by the invention the multi-sectional safety razor.

The multi-sectional safety razor bi-furcated the traditional one and half inch single blade into equal pieces ranging from at least 2 and going up.

These smaller square blades (FIG. 1) bear a hollowed out center (hole) which allows them to be fixed and looked into the razor head base (FIG. 2, 3, and FIG. 4 arrow 3). The razor base is made of plastic and there are plastic pegs protruding outwardly. The individual segmented razors (FIG. 1) look into place on the pegs (FIGS. 2 and 3).

A clear cover is heat fused to the razor enclosing the segmented razors to the razor head base. (FIG. 4 arrow 1).

This multi-sectional safety razor is a safe alternative to the existing disposable products that are currently sold on the market today. The shortened razors, that add up to a standard size blade cannot be converted into weaponry since they are small in size and heat sealed with a clear cover to detect if the segmented blades were tampered with or altered.

### BRIEF SUMMARY OF THE INVENTION

The primary object of the invention is to provide a safe alternative in the disposable razor market.

Another object of the invention is to provide a cheaper product that be readily produced. All materials used can be recycled and used again. Damaged blades can segmented and retrofitted to the pegs on the base of the razor head (FIG. 2, FIG. 3, and FIG. 4 arrow 3).

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a multi-sectional safety razor for shaving comprising: A plastic razor head mold with at least 2 and up in number of extending pegs (FIG. 2, FIG. 3, and FIG. 4 arrow 3). Looked into place on each peg is razor with a hollowed center (FIG. 1). A heat sealed clear cover is placed on top further stabilizing and locking the segmented razors into place. (FIG. 4 arrow 1).

### BRIEF DESCRIPTION OF THE DRAWINGS

The drawings constitute a part of this specification and include exemplary embodiments to the invention, which may be embodied in various forms. It is to be understood that in some instances various instances various aspects of the invention may be shown exaggerated or enlarged to facilitate an understanding of the invention.

FIG. 1 is a plan view of the invention

FIG. 2 is a perspective view of the invention

FIG. 3 is a plan view of the invention

FIG. 4 is a plan view of the invention

### DETAILED DESCRIPTION OF THE PREFERRED EMBODIMENTS

Detailed descriptions of the preferred embodiment are provided herein. It is understood however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

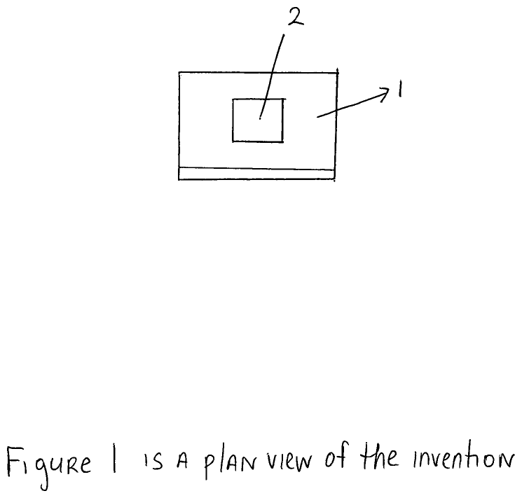

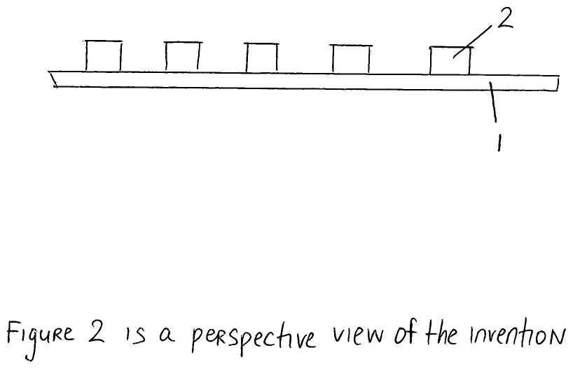

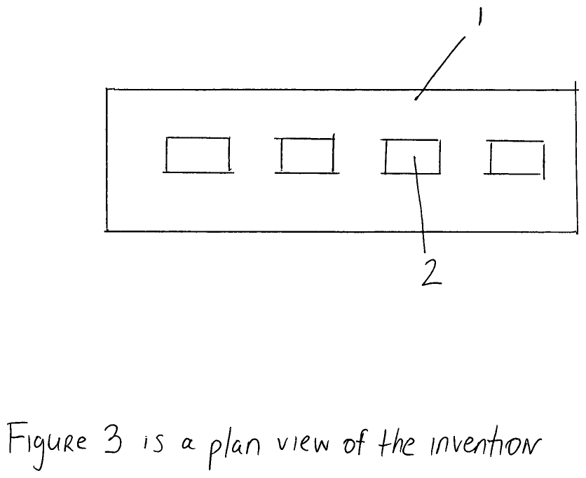

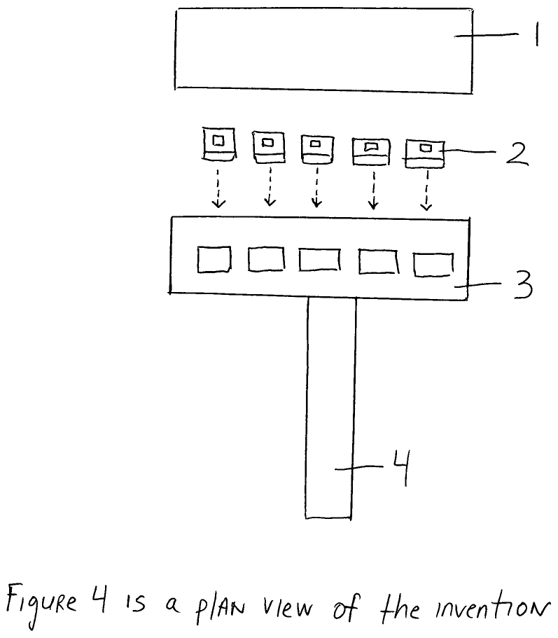

The multi-sectional disposable safety razor is a typical sized disposable razor with the following characteristics. The razor head is attached to a plastic handle (FIG. 4 #4). The razor head is manufactured as follows. The base of the razor head (FIG. 2 #1, FIG. 3, FIG. 4 #3) is made of plastic and it contains anywhere from 4 to 8 plastic pegs or projectiles protruding outwardly (FIG. 2 #2, and FIG. 3 #2). Segmented pinky length or smaller razors (FIG. 1 #1) that have a hole in the center (FIG. 1 #2) are looked in place on the outward pegs of the razor base (FIG. 4 #2, #3). To add to the safety and stability of the razor, a clear plastic cover (FIG. 4 #1) is heat sealed over the segmented razors. This multi-sectional safety razor shaves like a regular razor. The segmented razor sections work as one blade. The segmented blades are too small to be converted into a weapon or an unauthorised/unintended tool.

While the invention has been described in connection with a preferred embodiment, it is not intended to limit the scope of the invention to the particular fore set forth, but on the contrary, it is intended to cover such alternatives, modifications, and equivalents as may be included within the spirit and scope of the invention as defined by the appended claims.

What is claimed is:

1. A multi-sectional safety razor for shaving comprising of the following:
A typical sized disposable razor with a modified razor head consists of a razor head base with outward protruding pegs.
A typical disposable razor blade is out or segmented into much smaller units and looked into place on each of the protruding pegs.
These pegs while much smaller collectively work as one blade achieving the same results as a non-segmented bladed razor.
The entire razor head system is covered by a clear plastic covered that is heat sealed on the razor head.
